(19) United States
(12) Patent Application Publication
(10) Pub. No.: US 2020/0187120 A1
(43) Pub. Date: Jun. 11, 2020

(54) CONTROLLING CONNECTIVITY FOR DOZING OF WIRELESS DEVICE

(71) Applicant: Nokia Technologies Oy, Espoo (FI)

(72) Inventors: Olli ALANEN, Vantaa (FI); Enrico RANTALA, Berkeley, CA (US); Mika KASSLIN, Espoo (FI); Janne MARIN, Espoo (FI)

(21) Appl. No.: 16/614,665

(22) PCT Filed: Jun. 25, 2018
(86) PCT No.: PCT/FI2018/050489

§ 371 Date: Nov. 18, 2019

Related U.S. Application Data
(60) Provisional application No. 62/529,645, filed on Jul. 7, 2017.

(51) Int. Cl. H04W 52/02

(52) U.S. Cl. CPC H04W 52/0235

(57) ABSTRACT

This document discloses a solution for controlling connectivity of a dormant station. According to an aspect, a method comprises: entering, by a station of a wireless network, a dormant mode in which a main radio interface of the station is disabled and a wake-up radio interface of the station is enabled; scanning, by the station, for a beacon signal by using the wake-up radio interface in the dormant mode and determining, as a result of said scanning that no beacon signal is detected; as a response to said determining, switching by the station from the dormant mode, enabling the main radio interface, and transmitting to a wireless device a frame comprising an information element indicating incapability of detecting said beacon signal; and receiving, by the station from the wireless device, a frame indicating improved conditions for detecting a further beacon signal and, upon reception of the message, returning by the station to the dormant mode.

### FIELD

The invention relates to the field of wireless networks and, particularly, to controlling connectivity when a wireless device is capable of operating in an active mode and in a dormant mode.

### BACKGROUND

Wireless networks employ various power-saving features to reduce power consumption in battery-operated devices such as mobile devices. Networks based on IEEE 802.11 (Wi-Fi) specifications have introduced a power-save mode where a device may temporarily shut down its Wi-Fi interface to reduce the power consumption. Many other networks employ similar power-save modes that allow a battery-operated device to “doze” between frame transmissions or when there is no data to deliver. In the dozing state, the Wi-Fi or another main radio interface of the battery-operated device may be temporarily shut down. The dozing may have to be cancelled for receiving a data or control frame from the wireless network, for example. The device may be woken up by transmitting a wake-up frame to the device and, subsequently, the data or control frame may be transmitted to the device. However, if the device cannot receive the wake-up frame, the device may not be capable of receiving the data or control frame either.

### BRIEF DESCRIPTION

According to an aspect, there is provided the subject matter of the independent claims.

Embodiments of the invention are defined in dependent claims.

### LIST OF DRAWINGS

Embodiments of the present invention are described below, by way of example only, with reference to the accompanying drawings, in which

FIG. 1 illustrates an example of a wireless communication scenario to which embodiments of the invention may be applied;

FIG. 2 illustrates a flow diagram of an embodiment for operating modes of a station;

FIG. 3 illustrates a flow diagram of an embodiment for solving an issue in wake-up radio connectivity;

FIGS. 5 to 7 illustrate signalling diagrams of some embodiments for detecting an issue affecting a dormant mode of a station and for solving the issue; and

FIGS. 8 and 9 illustrate block diagrams of apparatuses according to some embodiments of the invention.

### DESCRIPTION OF EMBODIMENTS

The following embodiments are examples. Although the specification may refer to “an”, “one”, or “some” embodiment(s) in several locations, this does not necessarily mean that each such reference is referring to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general wireless communication scenario to which embodiments of the invention may be applied is illustrated in FIG. 1. FIG. 1 illustrates wireless communication devices comprising an access point (AP) 100 and a wireless terminal device also called as a station (STA) 110. FIG. 1 illustrates only a single station 110 but the number of stations may be higher. The access point 100 may be associated with a basic service set (BSS) which is a basic building block of an IEEE 802.11-based wireless local area network (WLAN). The most common BSS type is an infrastructure BSS that includes a single AP together with all STAs associated with the AP. The AP may be a fixed AP or it may be a mobile AP. The AP 100 may also provide access to other networks, e.g. the Internet. In another embodiment, the BSS may comprise a plurality of APs to form an extended service set (ESS). In yet another embodiment, a terminal device 110 may establish and manage a peer-to-peer wireless network to which one or more other terminal devices may associate. In such a case, the peer-to-peer wireless network may be established between two or more terminal devices and, in some embodiments, the terminal device managing the network may operate as an access node providing the other terminal device(s) with a connection to other networks, e.g. the Internet. In other embodiments, such routing functionality is not employed and the connection terminates in the terminal devices. Such a peer-to-peer network may be utilized for data sharing or gaming, for example.

The access node 100 may be connected to a network management system (NMS) 130 which may comprise an apparatus configured to maintain channel usage information of wireless networks of one or more access nodes and to configure the channel usage of the wireless networks. For example, it may arrange wireless networks located close to each other to operate on different channels and, thus, avoid interference between the networks. An example scenario is that access nodes of an enterprise are all controlled by the same NMS 130. In an embodiment, the network management system 130 is comprised in one of the access nodes, e.g. in the access node 100. In another embodiment, the network management system is realized by an apparatus different from the access nodes, e.g. by a server computer to which the access nodes may connect via a wired or wireless connection.

While embodiments of the invention are described in the context of the above-described topologies of IEEE 802.11 specifications, it should be appreciated that these or other embodiments of the invention may be applicable to networks based on other specifications, e.g. other versions of the IEEE 802.11, WiMAX (Worldwide Interoperability for Microwave Access), UMTS LTE (Long-term Evolution for Universal Mobile Telecommunication System), LTE-Advanced, a fifth generation cellular communication system (5G), and other networks having cognitive radio features, e.g. transmission medium sensing features and adaptiveness to coexist with radio access networks based on different specifications and/or standards. Some embodiments may be applicable to networks having features defined in the IEEE 802.19.1 specification. One example of a suitable communications system is the 5G system, as mentioned above.

With respect to the definition of the wireless network in the context of the present description, the wireless network may comprise a single BSS or a plurality of BSSs. According to a viewpoint, the wireless network may comprise a plurality of BSSs that have the same service set identifier (SSID) the same roaming identifier, and/or the same roaming partnership.

A station 110 may establish a connection with any one of access nodes it has detected to provide a wireless connection within the neighbourhood of the terminal device. The connection establishment may include authentication in which an identity of the terminal device is established in the access node. The authentication may comprise exchanging an encryption key used in the BSS. After the authentication, the access node and the station may carry out association in which the station is fully registered in the BSS, e.g. by providing the station with an association identifier (AID). It should be noted that in other systems terms authentication and association are not necessarily used and, therefore, the association of the station to an access node should be understood broadly as establishing a connection between the station and the access node such that the station is in a connected state with respect to the access node and waiting for downlink frame transmissions from the access node and its own buffers for uplink frame transmissions.

The station 110 may discover the access node 100 through a network discovery process. IEEE 802.11ai task group defines principles for fast initial link setup (FILS). One aspect of the principles is to enable faster and more precise AP and network discovery. Some principles may relate to passive scanning in which a scanning device, e.g. a STA, passively scans channels for any beacon, management, or advertisement frames. Other principles may relate to active scanning in which the scanning device actively transmits a scanning request message, e.g. a probe request message or a generic advertisement service (GAS) request, in order to query for present APs or networks. The probe request may also set some conditions that a responding device should fulfil in order to respond to the probe request. In some embodiments, the scanning device may be called a requesting device or a requesting apparatus. Responding devices may transmit scanning response messages, e.g. probe response messages, in response to the scanning request message, wherein the scanning response message may contain information on the responding device, its network, and other networks. Embodiments of the scanning enhancements described herein encompass the network discovery signalling, probe request-response processes, as well as GAS request-response processes.

Power consumption has always been an issue with all wireless networks and mobile communication. 802.11 specifications provide power-save mechanisms like a power save (PS) mode to save power when the STA is associated to an access node. In the PS mode, the STA may alternate between the active state and the doze state. By default, an associated STA is in active mode which enforces it to stay in an awake state where the STA is fully powered and able to transmit and receive frames with the access node. An associated STA may transition to the PS mode with explicit signalling and, while operating in the PS mode, it may save power by operating occasionally in a doze state. In the doze state, the STA is not able to transmit or receive frames but, on the other hand, power consumption of the STA is on a considerably lower level than in the awake state. The STA may wake up from the doze state to receive periodic beacon frames from the access node. While the STA is in the doze state, the access node buffers frames addressed to the STA. The access node transmits buffered multicast/groupcast frames after specific delivery traffic indication map (DTIM) beacon frames, when the STA is awake. Unicast frames may be transmitted only upon the STA in the PS mode has indicated that it has entered into the awake state. The access node indicates with the beacon frames (in a traffic indication map, TIM, field) whether it has frames buffered to the STA.

Recent developments in 802.11 work groups have involved introduction of a new low-power radio interface called a wake-up radio (WUR). The WUR has been discussed in a WUR study group. A new task group, TGba, has been established and it will continue the work of the study group. One purpose of the new radio interface is to enable further power-savings by allowing a main radio (also known as a primary connectivity radio) interface used for data communication according to 802.11 specifications to be turned off. The low-power radio interface is called in the study group a wake-up radio (WUR) receiver or a low-power WUR (LP-WUR) receiver, and it is considered to be a companion radio to the main radio interface providing primary connectivity. A wireless device such as the STA or an access node may comprise both the WUR and main 802.11 interface. An access node may comprise a wake-up transmitter and the main 802.11 interface. It has been proposed that the purpose of the wake-up radio interface is only or mainly to wake-up the main radio interface of a dozing station when the access node or another station has data to transmit to the dozing station.

The wake-up radio interface may be designed such that it consumes less power than the main radio interface. The wake-up radio interface may employ a simpler modulation scheme than the main radio interface, e.g. the wake-up radio interface may use only on-off keying (OOK) while the main radio interface uses variable modulations schemes such as phase-shift keying (PSK) and (quadrature) amplitude modulation (QAM).

Since the main purpose of the wake-up radio interface is to wake up the main radio interface, the wake-up radio interface may be powered on when the main radio interface is powered off. A wake-up radio interface of the STA may be configured to receive and extract wake-up signals (WUS) or wake-up frames (WUF) transmitted by a wake-up radio interface of the access node or another STA. The wake-up radio interface of the STA may be capable of decoding the wake-up radio frames on its own without any help from the main radio interface. Accordingly, the wake-up radio interface may comprise, in addition to a radio frequency front-end receiver components, digital baseband receiver components and a frame extraction processor capable of decoding contents of a wake-up radio frame. The wake-up radio frame may comprise a destination address field indicating a STA that should wake up the main radio interface, and the frame extraction processor may perform decoding of the destination address from a received wake-up radio frame and determine whether or not the destination address is an address of the STA of the frame extraction processor. If yes, it may output a wake-up signal causing the main radio interface to wake up for radio communication with an access node.

A wireless device managing a wireless network and comprising the main radio interface and the WUR interface may transmit two different types of beacon signals. The wireless device may transmit a first beacon signal by using the main radio interface and a second beacon signal by using the WUR interface. The first and second beacon signals may have different characteristics, e.g. different transmission parameters, different transmission periodicities, different lengths, different transmission timings, different transmission frequencies, and/or different contents. A beacon signal in general may be considered to be a discovery signal indicating presence or availability of the wireless network. A beacon signal may be broadcasted periodically.

FIG. 1 illustrates a scenario that may be relevant to a system employing two different radio access technologies with different transmission parameters. A radio coverage area 102 of the main radio interface of the access node 100 may differ from a radio coverage area 104 of the WUR interface of the access node 100. In many cases, the WUR coverage area 104 is smaller than the main radio coverage area 102. It may cause situations where a dormant station, such as the station 110 in FIG. 1, enters a dormant mode but is not capable of detecting a wake-up signal from the access node 100. As a consequence, the station 110 may not be able to enable its main radio interface and respond to communication attempts of the access node 100.

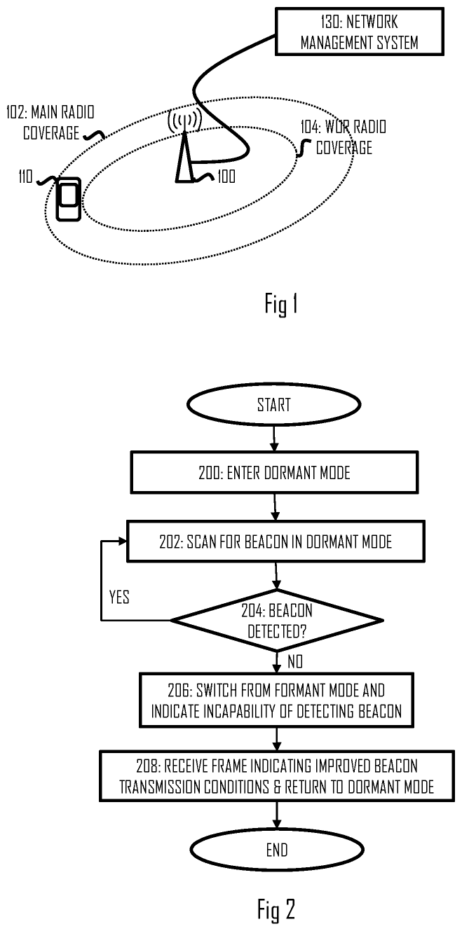

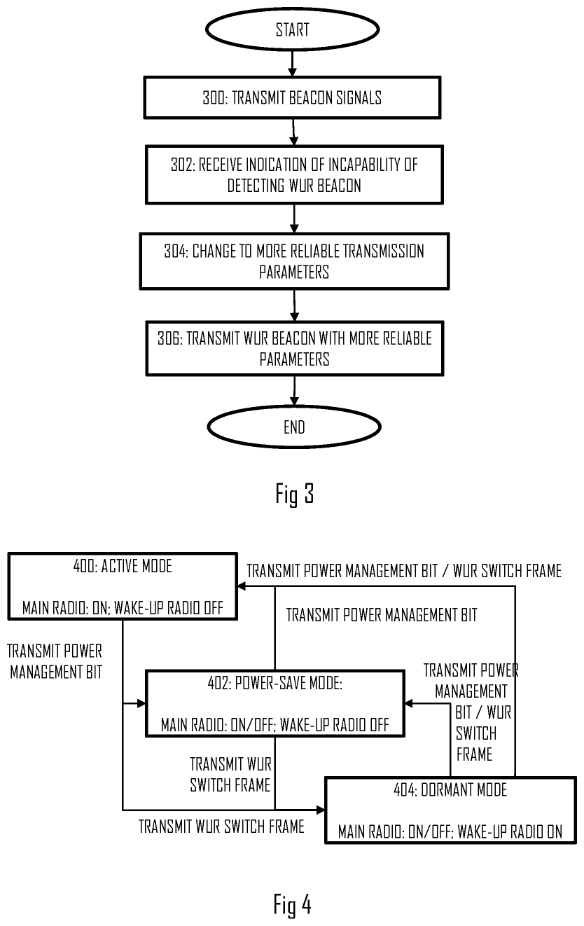

FIG. 2 illustrates a flow diagram of an embodiment for detecting and remedying WUR outage situations. Referring to FIG. 2, a method performed by the station comprises: entering a dormant mode in which a main radio interface of the station is disabled and a wake-up radio interface of the station is enabled (block 200); scanning for a beacon signal by using the wake-up radio interface in the dormant mode (block 202) and determining (block 204), as a result of said scanning that no beacon signal is detected (“NO” in block 204); as a response to said determining in block 204, switching from the dormant mode, enabling the main radio interface, and transmitting to a wireless device a frame comprising an information element indicating incapability of detecting said beacon signal (block 206); and receiving, in block 208 from the wireless device, a frame indicating improved conditions for detecting a further beacon signal and, upon reception of the message, returning by the station to the dormant mode.

Upon detecting the WUR beacon in block 204, the process may return to block 202.

FIG. 3 illustrates a flow diagram of another embodiment for detecting and remedying WUR outage situations. Referring to FIG. 3, a method performed by the access node or another wireless device comprises: transmitting a first beacon signal by using a main radio interface of the wireless device and transmitting a first wake-up radio beacon signal by using a wake-up radio interface of the wireless device (block 300), wherein the first wake-up radio beacon signal provides a smaller radio coverage area than the first beacon signal; receiving, in block 302 from a station a frame comprising an information element indicating incapability of the station to detect the first wake-up radio beacon signal; as a response to reception of said frame, changing transmission parameters of the a further wake-up radio beacon signal to new transmission parameters providing increased radio coverage area for the further wake-up radio beacon signal (block 304); and transmitting the further wake-up radio beacon signal by using the new transmission parameters (block 306).

FIGS. 2 and 3 may be based on the station monitoring the WUR connectivity to the wireless device and, upon detecting outage, the station may report the outage to the wireless device. This enables the wireless device to adjust the WUR beacon transmission settings such that the outage problem becomes solved. Thus, the station may return to the dormant mode.

In an embodiment, the first beacon signal and the main radio interface comply with 802.11 technology.

Let us now describe operational modes of the station with reference to FIG. 4. As described above, both the wireless device and the station associated to the wireless device may maintain up-to-date information on the current operational mode of the station. As described above, both the wireless device and the station may also comprise at least two radio interfaces having different communication configurations: the main radio interface and the wake-up radio interface. As described above, the wake-up radio interface may employ a transmission configuration that allow lower power consumption than with the main radio interface.

Referring to FIG. 4, in an active mode 400 the station may maintain its main radio interface powered constantly. On the other hand, the wake-up radio interface may be shut down while the main radio interface is powered. Therefore, the station employs only the main radio interface in the active mode 400. When the station is in the active mode 400, the wireless device may use only the main radio interface in all signalling with the station. In an embodiment, the active mode 400 complies with an active mode specified in IEEE 802.11 specifications.

In a power-save mode 402, the station may control the main radio interface to shut-down occasionally and in a controlled manner. The wake up radio interface may be shut down in the power-save mode 402. Accordingly, the station and the wireless device may communicate only with the main radio interface in the power-save mode. The station may, for example, power the main radio interface periodically to receive periodic beacon frames from the wireless device. As described above, the beacon frames may carry the TIM indicating whether or not the wireless device has buffered downlink data for the station. If the TIM indicates that there is downlink data to be transmitted to the station, the station may transmit a trigger frame to the wireless device to trigger the transmission of the downlink data. The trigger frame may trigger a service period in which multiple downlink frames may be transmitted. The service period is ended by the wireless device by explicit signalling, e.g. a subfield in a downlink frame. Thereafter, the station may shut down the main radio interface. In the 802.11 specifications, another mechanism is use of a power-save poll (PS Poll) frame which is an uplink frame transmitted by the station and indicating to the wireless device that the station is now awake and ready for receiving a downlink frame. After receiving the frame, the station may shut down the main radio interface or transmit another power-save poll frame.

When the station is a member of a groupcast/multicast group, the station may keep the main radio interface powered right after the reception of the periodic beacon such that a following groupcast/multicast frame may also be received. The wireless device may transmit the multicast/groupcast frames right after the beacon frames to enable devices in the power-save mode 402 to receive the multicast/groupcast frames. In a similar manner, broadcast frames may be transmitted right after the beacon frames.

In an embodiment, the power-save mode 402 is the power-save mode of IEEE 802.11 specifications.

In the dormant mode 404, the main radio interface may be shut down while the wake-up radio interface is powered on. In the dormant mode, the wireless device may contact the station with the wake-up radio interface. In the dormant mode 404, the station may keep the main radio interface shut down for extensive time intervals, e.g. for a duration longer than a main radio beacon transmission interval of the wireless device. The wireless device may further assume that the station will not check the periodic beacon frames transmitted with the main radio interface and, thus, gains no information on downlink frames, addressed to the station, buffered in the wireless device. As a consequence, upon buffering a downlink frame addressed to the station in the dormant mode 404, the wireless device may transmit a wake-up frame, via the wake-up radio interface, to the station. Receiving the wake-up frame through the wake-up radio interface may trigger the station to power up its main radio interface for frame transmission/reception.

In an embodiment, the wake-up receiver is powered on in all the operational modes 400, 402, 404.

Since the communication between the wireless device and the station depends on the operational mode of the wireless device, the wireless device and the station may exchange information on mode transitions of the station. Let us now consider how the mode transitions may be signalled.

The station may indicate transition between the modes 400, 402 by using a sub-field called a power management bit in a frame transmitted by the station to the wireless device. One value of the power management bit indicates that the station enters the active mode 400 while another value power management bit indicates that the station enters the power-save mode 402. This transition and explicit signalling of the mode transition may follow the IEEE 802.11 specifications.

In a similar manner, the transition between the modes 402, 404 or between the modes 400, 404 may be indicated by the station to the wireless device by using explicit signalling. The signalling may comprise an information element in a wake-up radio (WUR) switch frame. The WUR switch frame may be specified, for example, by using an action frame format of IEEE 802.11 specifications and defining a new frame or a new frame pair for the purpose of switching to/from the dormant mode 404. Alternatively, a new control type for an existing frame may be specified either by allocating a new sub-type value for the mode change signalling related to the mode 404. Yet another alternative is defining a new frame within an existing control frame extension space of IEEE 802.11 control frames. Table 1 below illustrates an embodiment of contents of the WUR switch frame:

TABLE 1

| Frame control | ID | BSSID (RA) | TA | Mode | FCS |
|---|---|---|---|---|---|
| 2 octets | 2 octets | 6 octets | 6 octets | 1 octet | 4 octets |

The frame control field may specify the type and, optionally, a sub-type of the frame, e.g. the WUR switch frame. The ID field comprises an association identifier for the association between the station and the wireless device. The BSSID (RA) field may comprise a receiver address for the frame indicating the BSS and the wireless device. The TA field comprises an address of the station. The Mode field may indicate the following: one value indicates entering the dormant mode 404 and another value indicates entering a power management mode, wherein the power management mode may be the power-save mode 402 or the active mode 400. The Mode field may have separate values indicating whether entering the active mode 400 or entering the power-save mode 402. However, this may not be needed, since it may be enough if Mode field indicates exit from dormant mode, since the above-described power management bit in the Frame Control field may still be used to indicate whether entering the active mode 400 or the power save mode 402. To sum up FIG. 4, when the station in the dormant mode 404 wishes to enter the active mode 400 from the dormant mode 404, the station may use the same procedure as when transitioning from the power-save mode 402 to the active mode 400 (the power management bit). However, in another embodiment, the station indicates the mode transition from the dormant mode to the active mode in the WUR switch frame and with a value of the Mode field. Also when switching from the dormant mode 404 to the power-save mode 402, the station may use the power management bit and/or the Mode field of the WUR switch frame to indicate the mode transition. Analogously, when transitioning from the active mode 400 directly to the dormant mode 404, the station may use the same procedure as when transitioning from the power-save mode 402 to the dormant mode 404 (the WUR switch frame). A frame check sequence (FCS) may be used for error detection.

The dormant mode 404 may be available only for connections between devices that both support the dormant mode and have the wake-up radio interface. In the case of a station associated to an access node, or another wireless device, the station may be provided with capabilities of the access node through scanning and association. An access node may indicate its capabilities in beacon, probe response and association response frames, for example. Support for the dormant mode and WUR capabilities may be indicated with means of one or more fields in such frames. The access node may be provided with capabilities of the station through the association procedure. The station may indicate its capabilities with means of one or more fields in an association request frame it transmits to the access node when initiation the association procedure.

In an embodiment, the station enters the dormant mode 404 immediately after completing association to the access node.

In an embodiment, the message indicating the improved conditions for detecting the WUR beacon signal indicates that the wireless device has changed to a more reliable modulation and coding scheme (MCS) when transmitting the WUR beacon signal. For example, the wireless device may initially transmit the WUR beacon signal by using a first modulation scheme, e.g. OOK, and then change to a more reliable second modulation scheme, e.g. non-OOK modulation or OOK modulation with more reliable transmission characteristics.

An example of OOK with more reliable transmission characteristics is an extended symbol length of each modulation symbol, e.g. longer duration of transmitting for indicating a value “one” and a longer duration of not transmitting for indicating a value “zero”. For example, the wireless device may employ by default transmission parameters that generate a first data rate in terms of kilobits per second. The data rate may build on a certain symbol length of OOK symbols with each carrying only one bit (a value ‘0’ or a value ‘1’). A variant of this first scheme employs a ½-rate coding with a shorter symbol length so that one bit is represented by two consecutive OOK symbols over which the coding is applied. This may result in the same data rate and substantially the same performance as the first scheme.

For longer radio coverage and more reliable performance of the WUR, as an example, symbol repetition may be applied. Two consecutive OOK symbols may be configured to carry one bit. The first scheme may be modified to have more reliable transmission parameters by configuring two (or multiple) subsequent OOK symbols to indicate a bit value ‘0’ (no carrier transmitted, “OFF”) or ‘1’ (carrier transmitted, “ON”). With the alternative using the coding, the two (or multiple) subsequent OOK symbols indicating a bit value need not to have the same value, i.e. the coding may determine which combination of symbol values indicates a bit value. As an example, OFF+ON may indicate a bit value ‘0’ and ON+OFF may indicate a bit value ‘1’). Both these solution may reduce the data rate in proportion to the number of consecutive symbols indicating a bit value. For example, if the change to the more reliable transmission parameters doubles the number of consecutive OOK symbols indicating a bit value, the data rate may be reduced to a half.

In another embodiment, message indicating the improved conditions for transmitting the WUR beacon signal indicates that the wireless device has increased transmission power of the WUR beacon signal.

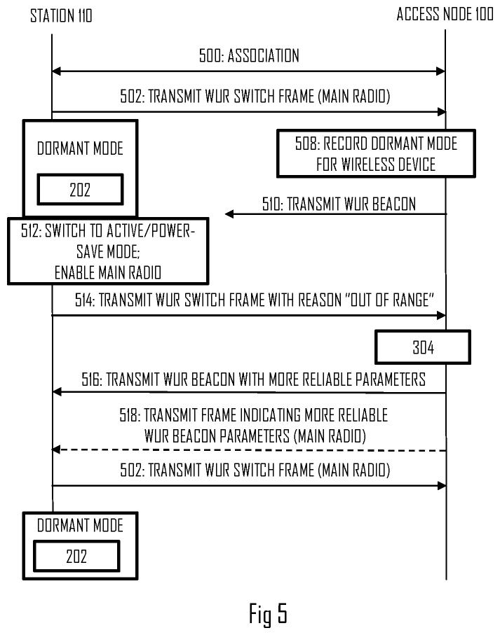

FIG. 5 illustrates a signalling diagram illustrating operation of the station 110 and the wireless device, e.g. the access node 100, and associated signalling between the devices 100, 110. Referring to FIG. 5, the devices 100, 110 may associate to one another in step 500. The association procedure may comprise operations described above. It may comply with 802.11 specifications. Upon determining to transit to the dormant mode, the station 110 may first transmit a WUR switch frame to the access node in step 502 by using the main radio interface and, thereafter enter the dormant mode (block 200). Upon receiving the WUR switch frame in step 502 and determining that the station 110 is switching to the dormant mode, the access node 100 may record the dormant mode as a current operational mode of the station 110 in block 508.

The access node 100 may transmit a WUR beacon signal periodically by using its WUR interface (step 510). Meanwhile, the station 110 may scan for WUR beacon frames in block 202 in the dormant mode, as illustrated in FIG. 5. Upon failing to detect the WUR beacon within a determined time window, the station 110 may execute block 512 in which the station 110 switches from the dormant mode to the active mode or to the power-save mode, for example, and enables the main radio interface. Upon powering up the main radio interface, the station 110 may transmit a WUR switch frame to the access node 100 in step 514. The WUR switch frame may comprise an information element indicating that the station 110 has switched from the dormant mode and enabled the main radio interface. The WUR switch frame may further carry the information element indicating incapability of the station to detect the WUR beacon signal. The information element may be comprised in the Mode field of Table 1. For example, the Mode field may have a dedicated value for switching to the active mode because of the incapability of detecting the WUR beacon signal and a dedicated, different value for switching to the active mode for another reason, e.g. without a specific reason code. The reason code of the incapability of detecting the WUR beacon signal may be “out of range”.

Upon receiving the WUR switch frame in step 514 and upon decoding the WUR switch frame, the access node 100 may detect the reason code and the incapability of the station 110 to detect the WUR beacon signal. As a consequence, the access node 100 may perform block 304. The access node may also update the operational mode of the station as the mode indicated in the WUR switch frame received in step 514.

Upon executing block 304, the access node 100 may transmit the WUR beacon signal with the adjusted transmission parameters in step 516. The station may keep scanning for the WUR beacon with the WUR interface during steps 514, 304, and 516 and, upon detecting the WUR beacon signal in step 516, the station may determine that it is within the coverage area of the WUR of the access node 100 and switch to the dormant mode. The switching may comprise step 502 in the above-described manner.

In an embodiment, upon executing block 304, the access node 100 may transmit other frames of the WUR interface with the adjusted transmission parameters as well. For example, execution of block 304 may cause a similar change to transmission parameters of the wake-up frames. Accordingly, not only the WUR beacon signals but also other WUR frames may be transmitted with improved coverage.

In an embodiment, the access node may transmit a further frame indicating the change to the more reliable transmission parameters in the transmission of the WUR beacon signal (step 518). The further frame may be transmitted by using the main radio interface. Meanwhile, the access node 100 may keep transmitting periodic WUR beacon signal with the improved radio coverage. In this embodiment, the station 110 may omit scanning for the WUR beacon with the WUR interface during steps 514, 304, and 516. Upon receiving the further frame in step 518, the station 110 may determine to switch to the dormant mode in the above-described manner.

In an embodiment, the access node may perform block 304 only upon receiving a determined number of indications of incapability of detecting the WUR beacons. The number may be two or higher than two.

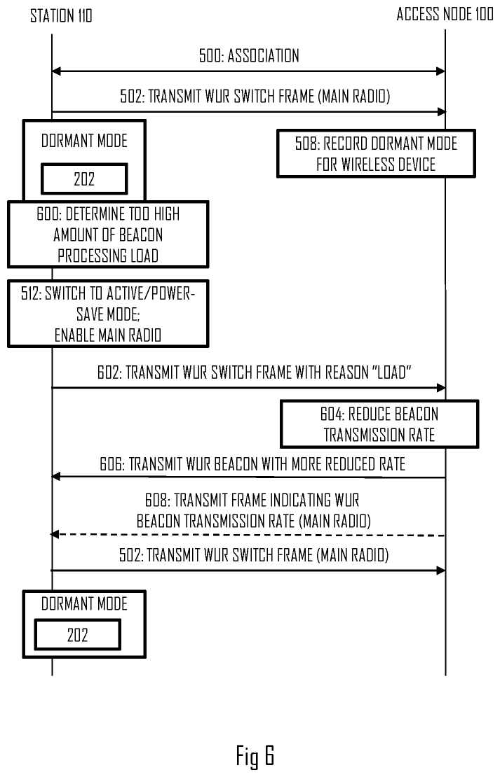

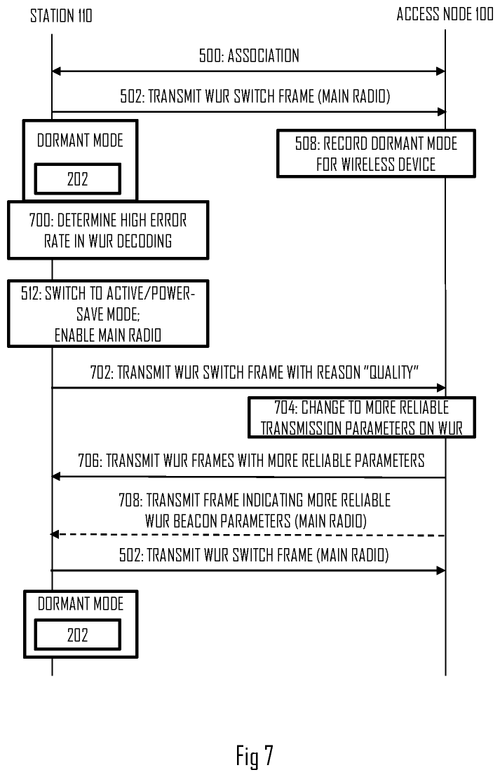

Some embodiments of the invention may employ other reason codes for switching from the dormant mode. FIGS. 6 and 7 illustrate such embodiments. In the embodiment of FIG. 6, the reason code is “load”, and in the embodiment of FIG. 7 the reason code is “quality”.

Referring to FIG. 6, the procedure may at first proceed as described above in connection with FIG. 5. Upon entering the dormant mode and scanning for the WUR beacons in block 202, the station 110 may determine in block 600 that the amount of WUR beacon processing load is too high. Such a situation may exist when there are multiple wireless networks broadcasting WUR beacons, and the station 110 needs to extract every detected WUR beacon. The processing load increases in systems where the station 110 cannot determine with physical layer processing whether or not a WUR beacon belongs to a network of the station 110. In such a case, the station 110 needs to perform higher layer processing to make such a determination, e.g. medium access control (MAC) layer processing. Accordingly, the processing load and associated power consumption may become significant for a station 110 that is in the dormant mode.

Upon determining that the WUR beacon processing load is too high, e.g. in a process where the station monitors processing load or power consumption of its WUR modem, the station 110 may execute block 512 and transmit a WUR switch frame to indicate the mode switch. In this case, the WUR switch frame may comprise an information element indicating that the reason for switching the mode is “load”, e.g. the too high processing load of WUR beacons. The station 110 may transmit and the access node 100 may receive the WUR switch frame in step 602. Upon receiving the WUR switch frame and, in some embodiments, at least one other WUR switch frame indicating the same reason code, the access node may reduce WUR beacon transmission rate in block 604. The access node may thus increase a period of transmitting the WUR beacons. That reduces the number of WUR beacons per time unit transmitted by the access node and will reduce the WUR beacon processing load of stations of the wireless network of the access node 100.

In step 606, the access node 100 transmits WUR beacon(s) with the reduced transmission rate. Meanwhile, the station 110 may keep monitoring the WUR beacon processing load and, upon detecting that the WUR beacon processing load reduces, the station may return the dormant mode in the above-described manner. In another embodiment, the access node 100 may transmit a frame indicating the reduced WUR beacon transmission rate through the main radio interface (step 608). The station 110 may receive the frame in step 608 by using its main radio interface and, upon receiving the frame and determining on the basis of the indication that the WUR beacon processing load has reduced, return to the dormant mode in the above-described manner.

Referring to FIG. 6, the procedure may at first proceed as described above in connection with FIG. 5. Upon entering the dormant mode and scanning for the WUR beacons in block 202, the station 110 may determine in block 700 that the quality of the WUR connection has degraded. The determination may be based on monitoring an error rate of received WUR frames and, for example, comparing the error rate with a threshold. The station 110 may be capable of detecting WUR frames but not capable of decoding contents of at least some of the WUR frames. Upon determining that the quality has degraded, the station may execute block 512 and transmit a WUR switch frame to indicate the mode switch. In this case, the WUR switch frame may comprise an information element indicating that the reason for switching the mode is “quality”, e.g. the incapability of decoding WUR frames. The station 110 may transmit and the access node 100 may receive the WUR switch frame in step 702. Upon receiving the WUR switch frame and, in some embodiments, at least one other WUR switch frame indicating the same reason code, the access node may change transmission parameters of the WUR frames in block 704. The new transmission parameters may provide for better decoding capability, e.g. a more reliable MCS and/or higher transmission power. The access node may thus reduce error rates of WUR frames.

In step 706, the access node 100 transmits WUR frames with the improved transmission parameters, e.g. WUR beacon signals and other WUR frames. Meanwhile, the station 110 may keep monitoring the WUR frames, e.g. WUR beacon frames, and upon detecting that the error rate of the received WUR frames has reduced, the station 110 may return to the dormant mode in the above-described manner. In another embodiment, the access node 100 may transmit a frame indicating the improved WUR frame transmission parameters through the main radio interface (step 708). The station 110 may receive the frame in step 708 by using its main radio interface and, upon receiving the frame and determining on the basis of the indication that the WUR error rates are reduced, return to the dormant mode in the above-described manner.

In general, the above-described embodiments enable the station 110 to inform the access node or the wireless device of a reason for switching from the dormant mode. In this manner, the station 110 may report any issues that prevent it from staying in the dormant mode. The access node 100 may, upon determining the issue on the basis of the report, then attempt to solve the issue such that the power savings in the station 110 may be improved. Upon determining that the issue has been solved, the station 110 may return to the dormant mode.

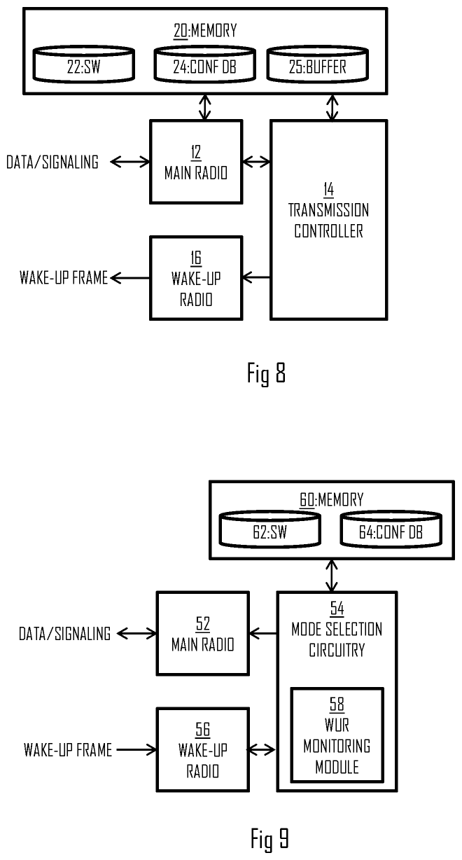

FIG. 8 illustrates an embodiment of a structure of the above-mentioned functionalities of the apparatus executing the process of FIG. 3 or any one of the embodiments performed by the wireless device, e.g. the access node 100. The apparatus may be the wireless device. The apparatus may comply with specifications of an IEEE 802.11 network and/or another wireless network. The apparatus may be defined as a cognitive radio apparatus capable of adapting its operation to a changing radio environment, e.g. to changes in parameters of another system on the same frequency band. The apparatus may be or may be comprised in a computer (PC), a laptop, a tablet computer, a cellular phone, a palm computer, or any other apparatus provided with radio communication capability. In another embodiment, the apparatus carrying out the above-described functionalities is comprised in such a wireless device, e.g. the apparatus may comprise a circuitry, e.g. a chip, a chipset, a processor, a micro controller, or a combination of such circuitries in any one of the above-described devices. The apparatus may be an electronic device comprising electronic circuitries for realizing the embodiments of the present invention.

Referring to FIG. 8, the apparatus may comprise the above-described main radio interface 12 configured to provide the apparatus with capability for bidirectional communication with other wireless devices such as the station 110. The main radio interface 12 may operate according to 802.11 specifications, for example. The main radio interface 12 may comprise analogue radio communication components and digital baseband processing components for processing transmission and reception signals. The main radio interface 12 may support multiple modulation formats.

The apparatus may further comprise the above-described wake-up radio interface 16 comprising a transmission circuitry for generating and transmitting the wake-up frames. The wake-up radio interface 16 may be configured for transmission only but, in some embodiments, the wake-up radio interface may enable uplink communications where the wake-up radio interface 16 has reception capability. The wake-up radio interface 16 may comprise analogue radio communication components and digital baseband processing components for processing transmission and reception signals. The wake-up radio interface 16 may support a single modulation scheme only, e.g. the on-off keying. In some embodiments, the wake-up radio interface 16 may support multiple modulation format but a lower number than supported by the main radio interface 12. In other embodiments where either one or more modulation formats are supported by the wake-up radio interface 16, the wake-up radio interface may support multiple alternative channel coding schemes.

The main radio interface 12 and the wake-up radio interface 16 may comprise radio interface components providing the apparatus with radio communication capability within one or more wireless networks. The radio interface components may comprise standard well-known components such as an amplifier, filter, frequency-converter, (de)modulator, and encoder/decoder circuitries and one or more antennas.

The apparatus may further comprise a memory 20 storing one or more computer program products 22 configuring the operation of at least one processor of the apparatus, e.g. a transmission controller 14 described below. The memory 20 may further store a configuration database 24 storing operational configurations of the apparatus. The configuration database may store, for example, current WUR beacon transmission parameters. The memory 20 may further store a buffer 25 storing downlink data addressed to stations associated to the apparatus.

The apparatus may further comprise a transmission controller 14 configured to control the operation of the main radio interface 12 and the wake-up radio interface 16. The transmission controller 14 may selectively use the main radio interface 12 and/or the wake-up radio interface 16 to communicate with stations associated to the apparatus and, additionally, with stations not associated to the apparatus. The transmission controller 14 may, for example, control the adjustments of the WUR frames on the basis of WUR switch frames and associated reason codes received from one or more stations. The transmission controller 14 may carry out any one of the blocks 304, 604, and 704.

In an embodiment, the apparatus comprises at least one processor and at least one memory 20 including a computer program code 22, wherein the at least one memory and the computer program code are configured, with the at least one processor, to cause the apparatus to carry out the functionalities of the wireless device or the access node according to any one of the embodiments of FIGS. 3 and 5 to 7. According to an aspect, when the at least one processor executes the computer program code, the computer program code causes the apparatus to carry out the functionalities according to any one of the embodiments of FIGS. 3 and 5 to 7. According to another embodiment, the apparatus comprises the at least one processor and at least one memory 20 including a computer program code 22, wherein the at least one processor and the computer program code 22 perform the at least some of the functionalities of the wireless device or the access node according to any one of the embodiments of FIGS. 3 and 5 to 7. Accordingly, the at least one processor, the memory, and the computer program code form processing means for carrying out embodiments of the present invention in the wireless device or the access node. According to yet another embodiment, the apparatus carrying out the embodiments of the invention in the wireless device or access node comprises a circuitry including at least one processor and at least one memory 20 including computer program code 22. When activated, the circuitry causes the apparatus to perform the at least some of the functionalities of the wireless device or the access node according to any one of the embodiments of FIGS. 3 and 5 to 7.

FIG. 9 illustrates an embodiment of a structure of the above-mentioned functionalities of the apparatus executing the process of FIG. 2 or any one of the embodiments performed by the station 110 in connection with FIGS. 4 to 7. The apparatus may be the station 110. The apparatus may comply with specifications of an IEEE 802.11 network and/or another wireless network. The apparatus may be defined as a cognitive radio apparatus capable of adapting its operation to a changing radio environment, e.g. to changes in parameters of another system on the same frequency band. The apparatus may be or may be comprised in a computer (PC), a laptop, a tablet computer, a cellular phone, a palm computer, or any other apparatus provided with radio communication capability. In another embodiment, the apparatus carrying out the above-described functionalities is comprised in such a device, e.g. the apparatus may comprise a circuitry, e.g. a chip, a chipset, a processor, a micro controller, or a combination of such circuitries in any one of the above-described devices. The apparatus may be an electronic device comprising electronic circuitries for realizing the embodiments of the present invention.

Referring to FIG. 9, the apparatus may comprise the above-described main radio interface 52 configured to provide the apparatus with capability for bidirectional communication with an access node or another wireless device operating a wireless network. The main radio interface 12 may operate according to 802.11 specifications, for example. The main radio interface 12 may comprise analogue radio communication components and digital baseband processing components for processing transmission and reception signals. The main radio interface 12 may support multiple modulation formats.

The apparatus may further comprise the above-described wake-up radio interface 56 comprising a reception circuitry for receiving the wake-up frames. The wake-up radio interface 56 may be configured for reception only but, in some embodiments, the wake-up radio interface may enable uplink communications where the wake-up radio interface 56 has transmission capability. The wake-up radio interface 56 may comprise analogue radio communication components and digital baseband processing components for processing transmission and reception signals. The wake-up radio interface 56 may support a single modulation scheme only, e.g. the on-off keying. As described, above, the wake-up radio interface 56 may, however, support multiple modulation and coding schemes.

The main radio interface 52 and the wake-up radio interface 56 may comprise radio interface components providing the apparatus with radio communication capability within one or more wireless networks. The radio interface components may comprise standard well-known components such as an amplifier, filter, frequency-converter, (de)modulator, and encoder/decoder circuitries and one or more antennas.

The apparatus may further comprise a memory 60 storing one or more computer program products 62 configuring the operation of at least one processor of the apparatus, e.g. a mode selection circuitry 54 described below. The memory 60 may further store a configuration database 64 storing operational configurations of the apparatus. The configuration database may, for example, store the current operational mode of the apparatus.

The apparatus may further comprise a mode selection circuitry 54 configured to switch the main radio interface 52 and the wake-up radio interface on and off according to the current operational mode of the apparatus. The mode selection circuitry may control the switching according to the state transitions, as described above in connection with FIG. 4. The mode selection circuitry 54 may further control the main radio interface to signal the mode transitions to the associated access node, as described above in connection with FIG. 4.

The mode selection circuitry 54 may comprise, as a sub-circuitry, a WUR monitoring module 58 configured to monitor the operation of the WUR interface 56 at least in the dormant mode. Depending on the embodiment, the WUR monitoring module may monitor for the detection of the WUR beacons in the dormant mode, processing load and/or power consumption in the dormant mode, and/or connection quality in the dormant mode. Upon determining on the basis of the monitoring that the performance in the dormant mode does not meet with pre-specified limits, the WUR monitoring module may cause the mode selection circuitry to switch from the dormant mode and cause transmission of the WUR switch frame with a reason code indicating the reason for the switch. The WUR monitoring module 58 may cause the mode switching on the basis of the performance of the WUR 56. The mode selection circuitry 54 may employ further mechanisms for switching from the dormant mode, e.g. upon reception of the WUS or WUF. The mode selection circuitry may include the reason code in the WUR switch frame only when the mode switching has been initiated by the WUR monitoring module 58.

In an embodiment, the apparatus comprises at least one processor and at least one memory 60 including a computer program code 62, wherein the at least one memory and the computer program code are configured, with the at least one processor, to cause the apparatus to carry out the functionalities of the station according to any one of the embodiments of FIGS. 2 and 4 to 7. According to an aspect, when the at least one processor executes the computer program code, the computer program code causes the apparatus to carry out the functionalities according to any one of the embodiments of FIGS. 2 and 4 to 7. According to another embodiment, the apparatus comprises the at least one processor and at least one memory 20 including a computer program code 22, wherein the at least one processor and the computer program code 22 perform the at least some of the functionalities of the station according to any one of the embodiments of FIGS. 2 and 4 to 7. Accordingly, the at least one processor, the memory, and the computer program code form processing means for carrying out embodiments of the present invention in the station. According to yet another embodiment, the apparatus carrying out the embodiments of the invention in the station comprises a circuitry including at least one processor and at least one memory including a computer program code 62. When activated, the circuitry causes the apparatus to perform the at least some of the functionalities of the station according to any one of the embodiments of FIGS. 2 and 4 to 7.

As used in this application, the term ‘circuitry’ refers to all of the following: (a) hardware-only circuit implementations, such as implementations in only analogue and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a wireless device.

The processes or methods described in connection with FIGS. 2 to 7 may also be carried out in the form of one or more computer processes defined by one or more computer programs. The computer program may be in source code form, object code form, or in some intermediate form, and it may be stored in a transitory or a non-transitory carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to wireless networks defined above but also to other suitable wireless communication systems. The protocols used, the specifications of wireless networks, their network elements and terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1-29. (canceled)

30. A method comprising:
entering, by a station of a wireless network, a dormant mode in which a main radio interface of the station is disabled and a wake-up radio interface of the station is enabled;
scanning, by the station, for a beacon signal by using the wake-up radio interface in the dormant mode and determining, as a result of said scanning that no beacon signal is detected;
as a response to said determining, switching by the station from the dormant mode, enabling the main radio interface, and transmitting to a wireless device a frame comprising an information element indicating incapability of detecting said beacon signal; and
receiving, by the station from the wireless device, a message indicating improved conditions for detecting a further beacon signal and, upon reception of the message, returning by the station to the dormant mode.

31. The method of claim 30, wherein the message indicating the improved conditions indicates that the wireless device has changed to a more reliable modulation and coding scheme when transmitting the further beacon signal.

32. The method of claim 30, wherein the station switches, as a response to said determining, from the dormant mode either to a power-save mode in which the main radio interface is intermittently enabled or to an active mode in which the main radio interface is constantly enabled.

33. The method of claim 30, wherein the station performs said transmitting and receiving in a mode where both main radio interface and wake-up radio interface are enabled.

34. The method of claim 30, wherein the frame transmitted by the station is a wake-up radio switch frame indicating that the station has switched from the dormant mode and enabled the main radio interface.

35. The method of claim 30, wherein the frame transmitted by the station is transmitted by using the main radio interface and the message received by the station is received by using either the wake-up radio interface or the main radio interface.

36. The method of claim 30, wherein the information element has a reason code “out of range”.

37. An apparatus comprising at least one processor; and at least one memory including computer program code, wherein the at least one memory and the computer program code are configured, with the at least one processor, to cause the apparatus to:
enter a dormant mode in which a main radio interface of the apparatus is disabled and a wake-up radio interface of the apparatus is enabled;
scan for a beacon signal by using the wake-up radio interface in the dormant mode and determine, as a result of said scanning that no beacon signal is detected;
as a response to said determining, switch from the dormant mode, enable the main radio interface, and cause transmission of a frame to a wireless device, the frame comprising an information element indicating incapability of detecting said beacon signal;
receive, from the wireless device, a message indicating improved conditions for detecting a further beacon signal and, upon reception of the message, return to the dormant mode.

38. The apparatus of claim 37, wherein the message indicating the improved conditions indicates that the wireless device has changed to a more reliable modulation and coding scheme when transmitting the further beacon signal.

39. The apparatus of claim 37, wherein the message indicating the improved conditions is the further beacon signal.

40. The apparatus of claim 37, wherein the at least one memory and the computer program code are configured, with the at least one processor, to cause the apparatus to switch, as a response to said determining, from the dormant mode either to a power-save mode in which the main radio interface is intermittently enabled or to an active mode in which the main radio interface is constantly enabled.

41. The apparatus of claim 37, wherein the at least one memory and the computer program code are configured, with the at least one processor, to cause the apparatus to perform said transmitting and receiving in a mode where both main radio interface and wake-up radio interface are enabled.

42. The apparatus of claim 37, wherein the frame is a wake-up radio switch frame indicating that the station has switched from the dormant mode and enabled the main radio interface.

43. The apparatus of claim 37, wherein the frame is caused to be transmitted through the main radio interface and the received message is caused to be received through either the wake-up radio interface or the main radio interface.

44. The apparatus of claim 37, wherein the information element comprises a reason code “out of range”.

45. An apparatus comprising at least one processor; and at least one memory including computer program code, wherein the at least one memory and the computer program code are configured, with the at least one processor, to cause the apparatus to:
transmit a first beacon signal by using a main radio interface of the apparatus and transmit a first wake-up radio beacon signal by using a wake-up radio interface of the apparatus, wherein the first wake-up radio beacon signal provides a smaller radio coverage area than the first beacon signal;
receive, from a station; a frame comprising an information element indicating incapability of the station to detect the first wake-up radio beacon signal;
as a response to reception of said frame, change transmission parameters of a second wake-up radio beacon signal to new transmission parameters providing increased radio coverage area for the second wake-up radio beacon signal; and
transmit the second wake-up radio beacon signal by using the new transmission parameters.

46. The apparatus of claim 45, wherein the at least one memory and the computer program code are configured, with the at least one processor, to cause the apparatus to change the transmission parameters by at least changing a modulation and coding scheme of the second wake-up radio beacon signal.

47. The apparatus of claim 45, wherein the at least one memory and the computer program code are configured, with the at least one processor, to cause the apparatus to transmit a further frame comprising an information element that specifies the change in the transmission parameters of the second wake-up radio beacon signal.

48. The apparatus of claim 47, wherein the at least one memory and the computer program code are configured, with the at least one processor, to cause the apparatus to transmit the further frame by using the main radio interface.

49. The apparatus of claim 45, wherein the at least one memory and the computer program code are configured, with the at least one processor, to cause the apparatus to trigger said change of the transmission parameters of the second wake-up radio beacon signal only upon receiving a plurality of frames from at least two different stations indicating incapability to detect the first wake-up radio beacon signal.
